(19) United States
(12) Patent Application Publication
(10) Pub. No.: US 2002/0182960 A1
(43) Pub. Date: Dec. 5, 2002

(54) Overlay trim member

(76) Inventor: Domenic Cosentino, Woodbridge (CA)

Correspondence Address: BACON & THOMAS, PLLC, 625 SLATERS LANE, FOURTH FLOOR, ALEXANDRIA, VA, 22314

(21) Appl. No.: 09/866,598

(22) Filed: May 30, 2001

(51) Int. Cl. B32B 27/12; B32B 21/02; B32B 21/10

(52) U.S. Cl. 442/286; 428/292.1; 428/292.4

(57) ABSTRACT

In an overlay trim member for, for example, the dashboard or other portion of an automobile, truck, recreational vehicle or as the case may be there is a main plate having at least one opening therein, and at least one insert plate which has a shape and dimensions corresponding to those of the opening in the main plate and is snugly disposed within the opening, the main plate and the insert plate being mounted on double-sided adhesive tape by which the overlay trim member may be operatively attached to the dashboard or other desired portion. The material or finish of the insert plate differs from that of the main plate thereby to provide enhancement of the aesthetic appearance of the overlay trim member.

The present invention relates to an overlay trim member which is operatively attached to, for example, the dashboard or other portion of an automobile, truck, recreational vehicle or as the case may be, in order to enhance the aesthetic appearance thereof.

An overlay trim member comprising a plate of, for example, wood veneer and of the appropriate shape and dimensions with the plate being operatively adhesively bonded in place is already known, and it is a primary object of the present invention to provide an improved form of overlay trim member which may be used to increase the enhancement of the aesthetic appearance of, for example, an automobile, truck, recreational vehicle or as the case may be.

In accordance with the present invention there is provided an overlay trim member comprising a main plate having at least one opening therein, and at least one insert plate which has a shape and dimensions corresponding to those of the opening and which is snugly disposed within the opening. The main plate and the insert plate are mounted on a backing member for attachment of the overlay trim member in place, and the material or finish of the insert member differs from that of the main plate.

In order that the invention may be more clearly understood and more readily carried into effect the same will now, by way of example, be more fully described with reference to the accompanying drawings in which:

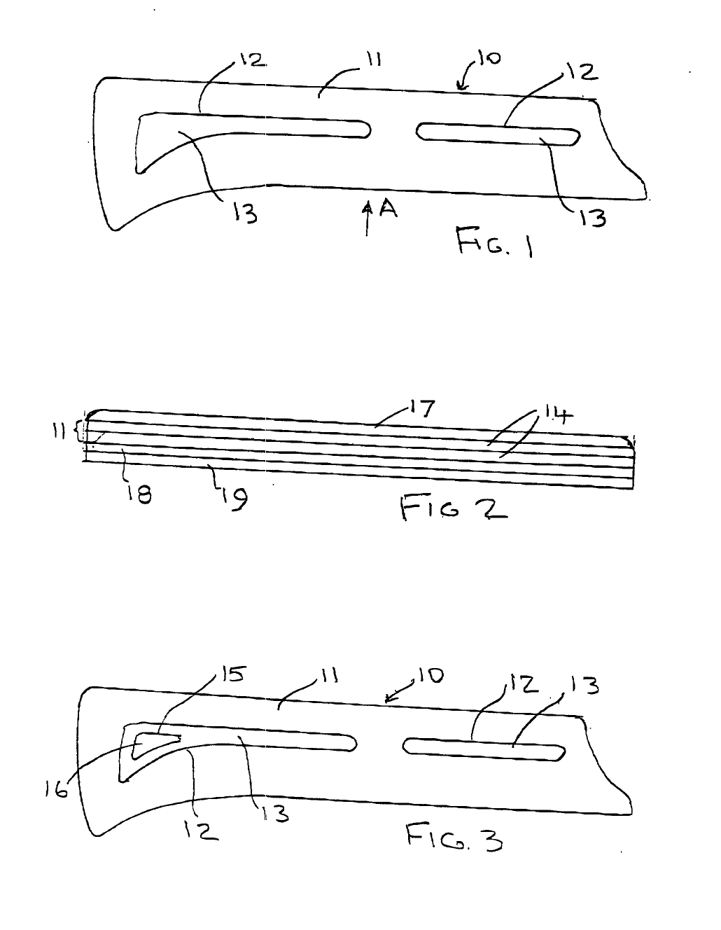

FIG. 1 is a view of an overlay trim member according to a preferred embodiment of the invention;

FIG. 2 is an edge view in the direction of the arrow A in FIG. 1 of the overlay trim member shown therein; and

FIG. 3 is a view corresponding to FIG. 1 of an overlay trim member according to an alternative embodiment of the invention.

Referring to the drawing, 10 denotes generally an overlay trim member which comprises a main plate 11 having two openings 12 therein, although it is to be understood that in alternative embodiments (not shown) of the invention there may be only one such opening 12 or more than two such openings 12. Snugly disposed within each of the openings 12 is an insert plate 13 with the shape and dimensions of each insert plate 13 corresponding to the shape and dimensions, respectively, of the associated opening 12.

As shown in FIG. 2 the main plate 11 may comprise two layers of wood veneer 14 which are bonded together, although it will be appreciated that the main plate 11 may comprise only one layer of wood veneer 14 or may comprise more than two layers 14 of wood veneer which are bonded together.

In alternative embodiments, the main plate 11, instead of being of wood, may be of any other suitable material such as, for example, carbon fiber, coloured composite weave, or a plastics material having a decorative film which is laminated thereon and which simulates, for example, wood, metal, or carbon fiber. The insert plate or plates 13 may likewise be of any suitable material or materials such as, for example, the above materials of which the main plate 11 may be formed.

The insert plate or plates 13 are of a different material and/or finish than the main plate 11 thereby to provide increased enhancement of the aesthetic appearance of the overlay trim member 10, and where there is more than one insert plate 13 the plurality of insert plates 13 may be of the same material and finish or or different materials and/or finish.

The alternative embodiment of the overlay trim member 10 shown in FIG. 3 corresponds to that hereinbefore described with reference to FIG. 1, except that one of the insert plates 13 has itself an opening 15 with an inner plate 16 of a shape and dimensions corresponding to the shape and dimensions of the opening 15 being snugly disposed therein. The material and/or finish of the inner plate 16 differs from the material and/or finish of the insert plate 13 in which it is disposed, and it will be appreciated that where there is a plurality of insert plates 13 they may all be provided with an opening 15 having snugly disposed therein an inner plate 16. Furthermore, more than one opening 15 may be provided in one of the insert plates 13, with an inner plate 16 being snugly disposed in each of the openings 15.

The inner plate or plates 16 may be of any suitable material or materials such as, for example, the above-described materials of which the main plate 11 may be formed.

A protective coating 17 of, for example, polyester, urethane, or epoxy may be provided on the main plate 11, or on the main plate 11 and the insert plates 13 (FIG. 1), or on the main plate 11, the insert plates 13 and the inner plate 16 (FIG. 3), and the main plate 11 and the insert plates 13 (FIG. 1) or the main plate 11, the insert plates 13 and the inner plate 16 (FIG. 3) are mounted on a backing member or members preferably comprising a double-sided adhesive tape 18 having a peel-off strip 19 which is operatively removed in order adhesively to bond the overlay trim member 10 to the desired portion of the automobile, truck, recreational vehicle or as the case may be.

The main plate 11 and the openings 12 therein together with the insert plates 13 (FIG. 1) or the main plate 11 and the openings 12 therein, the insert plates 13 and the opening 15 therein, together with the inner plate 16 (FIG. 3) may be formed by laser or water jet cutting.

It will of course be appreciated that where the portion of the automobile, truck, recreational vehicle or as the case may be to which the overlay trim member is to be attached is not flat the overlay trim member 10 is appropriately moulded or otherwise contoured to match the portion to which it is to be attached.

The insert plate or plates 13 and the inner plate or plates 16 may each be in the shape of a logo, letter or number.

It will of course be appreciated that in FIG. 2 the thicknesses of the coating 17, the wood veneers 14 comprising the main plate 11, and the double-sided adhesive tape 18 together with the associated peel-off strip 19 have been greatly exaggerated for clarity.

I claim:

1. An overlay trim member comprising a main plate having at least one opening therein, at least one insert plate which has a shape and dimensions corresponding to those of the opening and which is snugly disposed within the opening, and a backing member on which the main plate and the insert plate are mounted, the material and/or finish of the insert plate differing from that of the main plate.

2. An overlay trim member according to claim 1, wherein said at least one opening in the main plate comprises a plurality of openings therein, and said at least one insert plate comprises a corresponding plurality of insert plates, with each of the insert places having a shape and dimensions corresponding to those of one of the plurality of openings and being snugly disposed therein.

3. An overlay trim member according to claim 1, wherein said at least one insert plate has an opening therein, and an inner plate has a shape and dimensions corresponding to those of the opening in the insert plate and is snugly disposed within the opening in the insert plate, the material and/or finish of the inner plate differing from that of the insert plate.

4. An overlay trim member according to claim 1, wherein at least one of the plates comprising the main plate and the insert plate comprises at least one layer of wood veneer.

5. An overlay trim member according to claim 1, wherein at least one of the plates comprising the main plate and the insert plate comprises carbon fiber.

6. An overlay trim member according to claim 1, wherein at least one of the plates comprising the main plate and the insert plate comprises coloured composite weave.

7. An overlay trim member according to claim 1, wherein at least one of the plates comprising the main plate and the insert plate comprises plastics material having a decorative film laminated thereon.

8. An overlay trim member according to claim 3, wherein the inner plate comprises at least one layer of wood veneer.

9. An overlay trim member according to claim 3, wherein the inner plate comprises carbon fiber.

10. An overlay trim member according to claim 3, wherein the inner plate comprises coloured composite weave.

11. An overlay trim member according to claim 3, wherein the inner plate comprises plastics material having a decorative film laminated thereon.

12. An overlay trim member according to claim 1, wherein the main plate is provided with a polyester, urethane or epoxy coating.

13. A overlay trim member according to claim 1, wherein all the plates are provided with a polyester, urethane or epoxy coating.

14. An overlay trim member according to claim 1, wherein the backing member comprises double-sided adhesive tape.

15. An overlay trim member according to claim 1, wherein the trim member is non-flat.
